(19) United States
(12) Patent Application Publication
(10) Pub. No.: US 2015/0173859 A1
(43) Pub. Date: Jun. 25, 2015

(54) ORTHODONTIC APPLIANCE WITH LIGATING FEATURE

(71) Applicant: 3M INNOVATIVE PROPERTIES COMPANY, St. Paul, MN (US)

(72) Inventors: Frank C. Lin, San Diego, CA (US); Oliver L. Puttler, La Crescenta, CA (US)

(21) Appl. No.: 14/409,240

(22) PCT Filed: Jul. 1, 2013
(86) PCT No.: PCT/US2013/048910

§ 371 Date: Dec. 18, 2014

Related U.S. Application Data
(60) Provisional application No. 61/667,075, filed on Jul. 2, 2012.

(51) Int. Cl. A61C 7/28

(52) U.S. Cl. CPC A61C 7/287

(57) ABSTRACT

Provided are improved self-ligating appliances and methods that use a flexible “U”-shaped spring clip slidably engaged to the appliance body and have a cavity located on an outwardly-facing side of the appliance that includes a concave side surface that interrupts a side wall of the slot. The cavity is collectively defined by the body and one leg of the “U”-shaped clip when the clip is in its closed position and has a size sufficient to accommodate the tip of a hand instrument. By providing tactile feedback to the practitioner along surfaces of both the clip and appliance body, the appliance mechanism can be conveniently operated without a line of sight with the cavity.

### FIELD OF THE INVENTION

The provided appliances and methods generally relate to appliances used in orthodontic treatment. More particularly, the appliances and methods relate to orthodontic appliances that are self-ligating.

### BACKGROUND

Orthodontics is a specialization of dentistry concerned with the therapeutic movement of maloccluded teeth into proper positions in the oral cavity. There are many benefits of orthodontic treatment, including improved bite function, improved facial aesthetics, and easier maintenance of oral hygiene.

In a common mode of treatment called fixed appliance treatment, an orthodontic practitioner adhesively bonds a series of tiny slotted appliances, called brackets, to the surfaces of a patient's teeth. A resilient arch-shaped wire (or “archwire”), is then received in the slots of the brackets. The ends of the archwire are typically captured in tube-like appliances, called molar tubes, which are bonded to the patient's molar teeth. While the archwire is initially deflected from its original shape, it applies gentle forces to the teeth as it springs back during treatment, and functions as a track for unraveling the associated maloccluded teeth. By progressively adjusting the size and cross-sectional shape (typically round or rectangular) of the archwire, a practitioner can obtain increasing levels of control during later stages of treatment.

Various technologies can be used to secure the archwire into the slots of the brackets during treatment. One method is to use an elastic “O”-ring ligature to tie the archwire to each bracket with the assistance of lugs, called tiewings, which are located on opposing sides of the bracket slot. An alternative method is to use a thin piece of ligature wire, which is looped over the archwire and around the tie-wings, then secured tightly. Certain brackets have been developed that use a self-locking mechanism to engage the archwire in the slot without the need for a ligature or ligature wire. These are known as self-ligating appliances. Some practitioners prefer these appliances because they may simplify the ligation process, decrease frictional resistance to sliding in early stages of treatment, and promote better hygiene.

Self-ligating appliances come in many forms and use different mechanisms for securing the archwire in the slot. One self-ligating bracket concept uses a built-in flexible “U”-shaped spring clip; one leg of the clip slides through a passageway in the appliance body, while the other leg slides over the frontal face of the body to control ingress and egress of an archwire. One of the benefits of this approach derives from the elastic nature of the clip. An elastic clip can provide active ligation, where the clip imparts a continuous force urging the archwire toward the bottom of the slot. Some practitioners favor active ligation, particularly with square and rectangular archwires, because “actively” seating these wires into the bracket slot can more effectively transmit torque to the teeth. In passive ligation, on the other hand, the archwire is permitted to “float” freely within the archwire slot. One perceived advantage of passive ligation is reduced friction.

### SUMMARY

While the “U”-shaped clip of the self-ligating appliance described above can be shaped to embrace the body of the appliance while sliding smoothly between open and closed positions, the clip may not necessarily maintain the same shape throughout treatment. Forces imparted to the clip by the archwire, or repetitive opening and closing of the clip, can gradually cause the clip to deform “open” over time. Various engineering considerations can also contribute to this problem. To provide the desired flexibility and reduce the appliance profile, for example, the clip is usually made quite thin, but this also can make the clip susceptible to permanent deformation. The clip and body are also subject to manufacturing tolerances based on variability in their dimensions. When the clip and appliance body do not fit perfectly for any of the aforementioned reasons, the clip can rattle or wobble in the appliance, which reduces confidence of the practitioner that the clip is closed. In some cases, the clip could even spontaneously open and/or become dislodged from the appliance body as a result of a poor fit between the clip and associated appliance body.

Another problem with conventional self-ligating appliances relates to ease of use. Because the doors, clips, or other ligating members used in bonded orthodontic appliances are generally tiny and delicate, they can be difficult to manipulate by an inexperienced practitioner. In some cases, orthodontic manufacturers require use of specialized hand instruments to avoid distortion of the clip when repeatedly opening and closing the appliance mechanism. Even so, however, a line of sight is generally required to engage the hand instrument with the appliance mechanism. When working with appliances bonded to posterior teeth, such as molar teeth, such a line of sight may not be easily achieved. Again, improper technique can lead to appliance damage.

Herein described are improved self-ligating appliances and related methods that can alleviate the above problems. These appliances use a resilient “U”-shaped clip having a labial and a lingual leg and a cavity located on the labial side of the appliance that includes a concave side surface interrupting a side wall of the archwire slot. The cavity is collectively defined by the body and the labial leg when the clip is in its closed position and has a size sufficient to accommodate the tip of a hand instrument. By interrupting the side wall of the archwire slot, the cavity provides tactile feedback to the practitioner as a tip of a hand instrument is traced along the slot, enabling the appliance to be conveniently operated without a line of sight with the cavity. Optionally, the appliance has a groove located on a labial or lingual side of the body on an opposite side of the slot from the cavity and generally aligned with the cavity along a common occlusal-gingival axis to prevent distortion of the clip as it is opened and closed.

In one aspect, an orthodontic appliance is provided. The orthodontic appliance comprises: a base; a body extending outwardly from the base and having an elongated slot thereon that extends along a generally mesial-distal direction, the slot having a bottom wall and pair of opposing occlusal and gingival side walls; a clip slidably engaged to the body and movable between open and closed positions, the clip comprising a first leg extending over at least a portion of the slot when the clip is in its closed position and a second leg joined to the first leg and slidably received in a passageway extending through the body along a generally occlusal-gingival direction; and a cavity located on the labial side of the appliance and comprising a concave side surface that interrupts a side wall of the slot, the cavity collectively defined by the body and labial leg when the clip is in its closed position and having a size sufficient to accommodate the tip of a hand instrument.

Optionally, the appliance comprises a retaining recess located on one of the side walls for receiving the leading edge, wherein the first leg has a leading edge and a first locking surface adjacent the leading edge, with the retaining recess including a second locking surface and the clip being compressively pre-stressed whereby the first and second locking surfaces urge against, and complementally engage, each other to retain the clip in its closed position.

Optionally, the appliance comprises a groove located on a labial side of the body on an opposite side of the slot from the cavity and generally aligned with the cavity along a common occlusal-gingival axis.

In another aspect, a method of actuating an orthodontic appliance having a body and a generally “U”-shaped clip slidably engaged to the body and having a first and second leg, the first leg at least partially extending across an elongated slot located on the body, is provided. The method comprises: inserting the tip of a hand instrument into a cavity disposed along a space between the first leg and outward-facing side of the body, the cavity being at least partially defined by both the first leg and body to provide tactile feedback along both outward-facing and occlusal-facing surfaces; and drawing the tip along a groove located on the outward-facing side of the body and extending along generally occlusal-gingival direction on an opposite side of the slot from the cavity thereby applying a force vector to the clip that avoids straining the first and second legs in directions apart from each other.

Optionally, the first leg is a labial leg, the second leg is a lingual leg, and the outward-facing side is a labial side, wherein the groove guides the tip along a generally linear path of movement offset in a lingual direction from the outward-facing side of the body.

### BRIEF DESCRIPTION OF THE DRAWINGS

FIG. 1 is a distal perspective view of an assembled appliance according to one embodiment, looking toward its distal, gingival, and labial sides.

FIG. 2 is a plan view of the appliance of FIG. 1, looking toward its labial side.

FIG. 3 is a side elevational view of the appliance of FIGS. 1-2, looking toward its distal side.

FIG. 4 is a front perspective view of the appliance of FIGS. 1-3, looking toward its labial, mesial, and occlusal sides.

FIG. 5 is a perspective view of one component of the appliance of FIGS. 1-4, looking toward its labial, mesial, and occlusal sides.

FIG. 6 is a side elevational view of the component in FIG. 5, looking toward its mesial side.

FIG. 7 is an enlarged fragmentary view of the component of FIGS. 5-6 based on the inset region of FIG. 6.

FIG. 8 is an enlarged fragmentary view of the component in FIGS. 5-7 as assembled and further showing an exemplary mechanical interaction with associated archwire and clip components;

FIG. 9 is a plan view of the embodiment of FIGS. 5-8, looking toward its labial side.

FIG. 10 is an occlusal perspective view of the component of FIGS. 5-9, looking toward its occlusal, labial, and distal sides.

FIG. 11 is a cross-sectional side elevational view of the component of FIGS. 5-10 along the line 10-10 in FIG. 9, looking toward a distal-facing cross-sectional surface.

### DEFINITIONS

As used herein:

“Mesial” means in a direction toward the center of the patient's curved dental arch.

“Distal” means in a direction away from the center of the patient's curved dental arch.

“Occlusal” means in a direction toward the outer tips of the patient's teeth.

“Gingival” means in a direction toward the patient's gums or gingiva.

“Labial” means in a direction toward the patient's lips or cheeks.

“Lingual” means in a direction toward the patient's tongue.

### DETAILED DESCRIPTION

Illustrative embodiments of the invention directed to self-ligating orthodontic appliances and related methods are herein provided. These embodiments are exemplary and should not be construed to unduly limit the invention. For example, it is to be understood that one of ordinary skill can adapt the disclosed appliances and methods for attachment to either the labial or lingual surfaces of teeth, to different teeth within the same dental arch (for example, corresponding appliances on mesial and distal halves of the dental arch), and to teeth of either the upper or lower dental arches.

If desired, the appliances and methods described herein may be customized or non-customized to the individual patient undergoing treatment. Embodiments could include one or more appliance components that are made from a translucent material, such as a ceramic, for improved aesthetics. Further, material and dimensional specifications could vary from those disclosed herein without departing from the scope of the claimed invention. For example, the provided appliances could use clips made from any of a variety of resilient metal or polymeric materials known in the art.

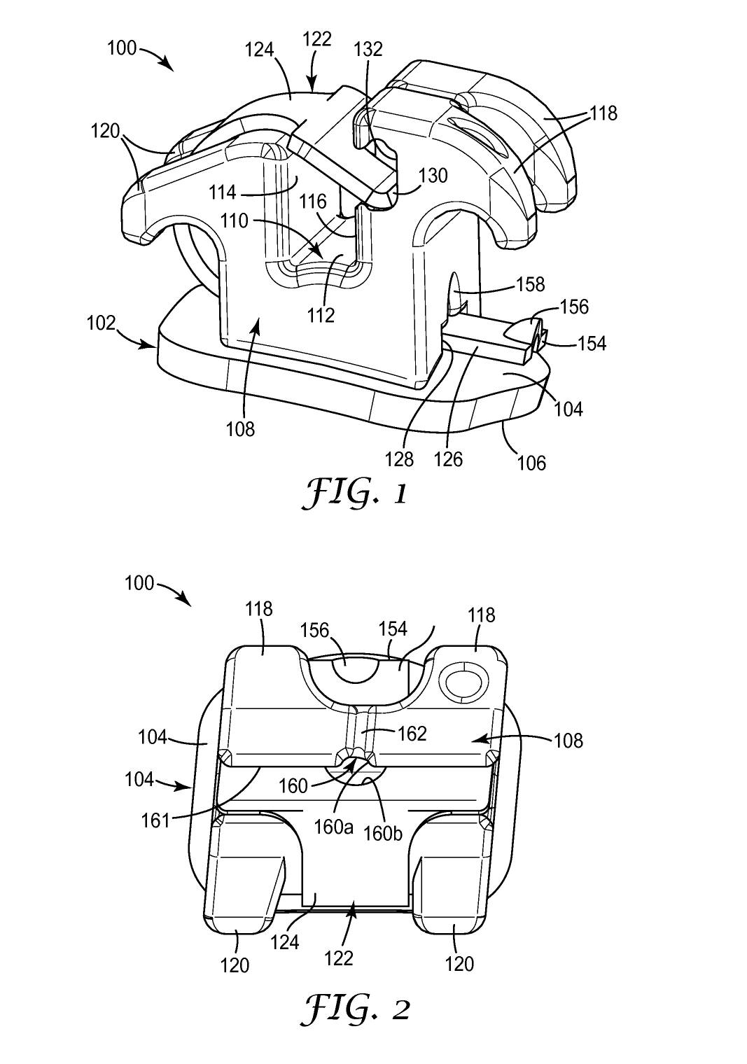

One exemplary embodiment is shown in FIGS. 1-4, where an orthodontic appliance is illustrated and designated by the numeral 100. As shown, the appliance 100 is a labial bracket adapted for bonding to the front surface of a patient's tooth. The appliance 100 has a bonding base 102 with a labial surface 104 and a lingual surface 106 having a concave geometry substantially matching a convex surface of the associated tooth surface. In preferred embodiments, the outer lingual surface 106 includes a metal mesh, holes, bumps, recesses, undercuts, microetched surface, glass grit, bonded particles, organo-silane treatment, or any other known mechanical or chemical modification that could enhance adhesive bonding between the base 102 and the underlying tooth. Alternatively, the base 102 could also have a banded configuration in which the base 102 fully encircles the tooth to provide an even stronger bond.

Referring to FIG. 1, an appliance body 108 extends outwardly from the inner labial surface 104 of the base 102. In exemplary embodiments, the body 108 and base 102 are both made from metal, such as stainless steel, and are welded or soldered to each other. However, as an alternative, one or both of the body 108 and base 102 could be made from a polymeric material such as polycarbonate or ceramic material such as polycrystalline alumina Optionally, one or both of these components could be molded as an integral piece, for example by metal injection molding, or machined from a unitary metal or ceramic blank using computer-controlled methods known to those of skill in the art.

An elongated archwire slot 110 extends across the labial surface 104 of the body 108 along a generally mesial-distal direction. As shown in FIG. 1, the slot 110 has a bottom wall 112 and opposing occlusal and gingival side walls 114, 116. The walls 112, 114, 116 present three sides of a generally rectangular enclosure for accommodating a suitable orthodontic archwire (not shown) during the course of treatment. Extending from the body 108 are a pair of gingival tie wings 118 and a pair of occlusal tie wings 120 to assist in manually ligating the archwire in the slot 110 using a separate O-ring or wire ligature, if desired by the practitioner.

A resilient, generally “U”-shaped clip 122 is slidably engaged to the body 108 and includes a labial leg 124 and a lingual leg 126 joined to the labial leg 124. The lingual leg 126 is generally planar and received in a passageway 128 extending through the body 108 in a generally occlusal-gingival direction, allowing the clip 122 to reversibly slide between open and closed positions thus permitting or blocking access to the archwire slot 110, respectively.

In FIGS. 1-4, the clip 122 shown in its closed position. In this position, the labial leg 124 of the clip 122 extends across the labial opening of the slot 110 along essentially its entire mesial-distal length. By maximizing the mesial-distal length over which the appliance 100 can engage an archwire received in the slot 110, this feature can help provide an enhanced degree of control between the archwire and associated appliance 100. Referring now to FIG. 4, the labial leg 124 has a leading edge 130 that is divided by a central notch 134 into mesial and distal sections 130a and 130b. The sections 130a, 130b are received in respective retaining recesses 132 located on the mesial and distal sides of the gingival side wall 116 of the archwire slot 110. Located between the retaining recesses 132 is a central post 136 registers with the central notch 134 when the clip 122 is in its closed position. The central post 136 helps preserve torque expression in the appliance 100 by preventing an archwire from entering the retaining recesses 132 as it twists along its axis.

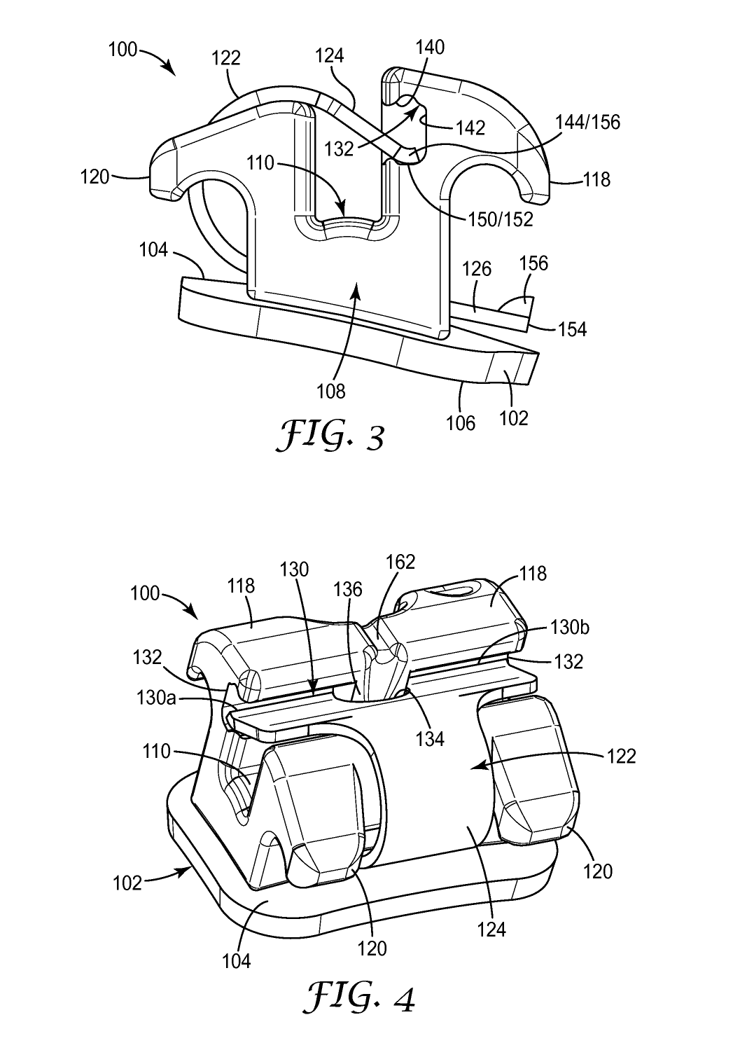

FIG. 3 shows the appliance 100 in distal view and reveals additional aspects of the distal retaining recess 132. As shown, this retaining recess 132 has a lingual-facing surface 140, an occlusal-facing surface 142, a labial-facing surface 144, and a distal facing surface 146. Located on the labial-facing surface 144 and adjacent the leading edge 130 is a first locking surface 150. Located on the opposing lingual-facing surface of the labial leg 124 is a second locking surface 152. The first and second locking surfaces 150, 152 have contours that complementally engage each other when the clip 122 is in its closed position. This engagement between the clip 122 and body 108 is facilitated by pre-stressing the clip 122 such that the clip 122 normally exerts a compressive force on the body 108 when assembled. As a result of this pre-stressed state, the labial leg 124 of the clip 122 is urged against the labial-facing surface 144 of the retaining recess 132 any time that the clip 122 is in its closed position.

The compressive engagement of the clip 122 results in a mutual engagement between the locking surfaces 150, 152. This engagement, in turn, helps prevent the clip 122 from significantly sliding in the occlusal or gingival directions unless a threshold amount of force is applied to the clip 122. Functionally, the interaction of the locking surfaces 150, 152 helps retain the clip 122 in a stable position within the retaining recesses 132. By contrast, conventional “U”-shaped clips used in similar self-ligating appliances have a tendency to rattle when they reside in their closed positions, particularly when acting in a passive ligation mode. Because the surfaces 150, 152 are maintained in a locking engagement by the elastic resilience of the clip 122, the rattling problem is avoided and the practitioner has greater confidence that the clip 122 is closed.

As shown here, the first locking surface 150 on the retaining recess 132 is a concave surface, while the second locking surface 152 on the clip 122 is a convex surface. In some embodiments, at least a portion of the concave surface on the retaining recess 132 has a normal vector with a positive component in the gingival direction. By having a surface that faces, at least in part, toward the gingival direction, the retaining recess 132 creates an interference with the second locking surface 152 of the labial leg 124 thereby restricting movement of the clip 122 toward the occlusal (opening) direction.

Also possible are other matching geometries that form a mating engagement when aligned and placed into contact with each other. In some embodiments, for example, the concave and convex surfaces are reversed between the first and second locking surfaces 150, 152. In other embodiments, one locking surface 150, 152 includes one or more geometric elements, such as posts, pyramids, cubes, cones, ridges, hemispheres or combinations thereof, and engages an opposing locking surface 150, 152. The opposing locking surface 150, 152 optionally has, for example, a substantially matching inverse topology.

Optionally and as shown in exemplary FIG. 1, the lingual leg 126 has a trailing edge 154 and a bump 156 adjacent the trailing edge 154 and protruding in a labial direction. The bump 156 engages with a catch 158 located adjacent to the entrance of the passageway 128 when the clip 122 slides toward its open position. The catch 158 arrests the occlusal sliding of the lingual leg 126 through the passageway 128 and prevents the clip 122 from becoming dislodged during normal operation of the appliance 100.

The clip 122 may be either discrete or unitary in their construction and can be made from any of a number of resilient materials known to the skilled artisan. As shown, the labial leg 124 and lingual leg 126 are formed from a single flat sheet of resilient material. Preferably, the clip 122 is made from a metal such as stainless steel, titanium, cobalt-chromium alloy (such as manufactured by Elgiloy Specialty Metals, Elgin, Ill.), or a shape memory metal such as an alloy of nickel and titanium. It is also preferred that the clip 122 is sufficiently resilient so that the shape of the clip 122 when relaxed does not significantly change during the course of treatment. Further optional aspects of the clip 122 are described in co-pending provisional U.S. Patent Application Ser. No. 61/476,907 (Lin, et al.).

Referring now to FIG. 2, the labial side of the appliance 100 has a cavity 160 that interrupts the gingival side wall 114 of the slot 110, the cavity 160 collectively defined by the body 108 and labial leg 124 when the clip 122 is in its closed position. As shown, the cavity 160 is approximately located at the mesial-distal midpoint of the side wall 114 and includes a pair of concave side surfaces 160a, 160b (on the body 108 and labial leg 124, respectively) that are in opposition to each other in labial plan view. Preferably the cavity 160 has a size sufficiently large to accommodate the tip of a suitable hand instrument, such as an orthodontic explorer.

Advantageously, cavity 160 is located along a mesial-distal space 161 between the labial leg 124 of the clip 122 and the gingival side wall 114 of the slot 110 (as viewed in FIG. 2), whereby a practitioner can lightly trace the tip of the pointed instrument along the space 161 until the tip descends into the cavity 160. Using the cavity 160 as a purchase point, the practitioner can then apply a gentle downward (occlusal) force with the instrument and tug open the clip 122 for placement or removal of an archwire. This configuration represents a significant improvement in the art because, unlike prior art appliances, the appliance 100 does not require that a practitioner visually locate a purchase point to slide open the clip. By providing tactile feedback to the practitioner, the appliance 100 can be operated without a line of sight with the cavity 160. As a further advantage, the cavity 160 presents tactile feedback along both labial-facing and occlusal-facing surfaces. Providing tactile identification of the cavity 160 from multiple surfaces is of great convenience to the practitioner and can improve comfort for the patient, particularly when the appliance 100 is bonded in the posterior region of the mouth and where obtaining visual identification is difficult or leads to patient discomfort.

In some embodiments, the cavity 160 is enclosed as viewed from the labial direction. In other embodiments, the cavity 160 has a geometry that is at least partially defined by a cylinder or cone. For example, the concave side surface 160a could be inscribed within a cylinder that intersects the gingival side wall 114, the cylinder having a radius generally matching the outer radius of the tip of an orthodontic hand instrument. Preferably, the radius of the inscribing cylinder is at least about 5 mils (127 micrometers), at least about 6 mils (152 micrometers), or at least about 7 mils (178 micrometers). Preferably, the radius of the inscribing cylinder is at most about 30 mils (762 micrometers), at most about 20 mils (508 micrometers), or at most about 10 mils (254 micrometers). The cavity 160 could also have a semi-cylindrical shape, where the side surface 160a is generally concave and the side surface 160b is generally planar, or vice versa. Alternatively, the cavity 160 could be elliptical, rectangular, or any other shape suitable for engaging the tip of an orthodontic hand instrument.

As another optional feature, a narrow scribe line 162 can be located on the labial surface of the body 108 and can be used to assist in positioning the appliance 100 on the patient's tooth. In one embodiment, for example, a practitioner aligns the scribe line 162 along the perceived long axis of the tooth. As shown, the scribe line 162 extends in a generally occlusal-gingival direction along a reference plane generally perpendicular to the archwire slot 110, the reference plane generally dividing the appliance into mesial and distal portions.

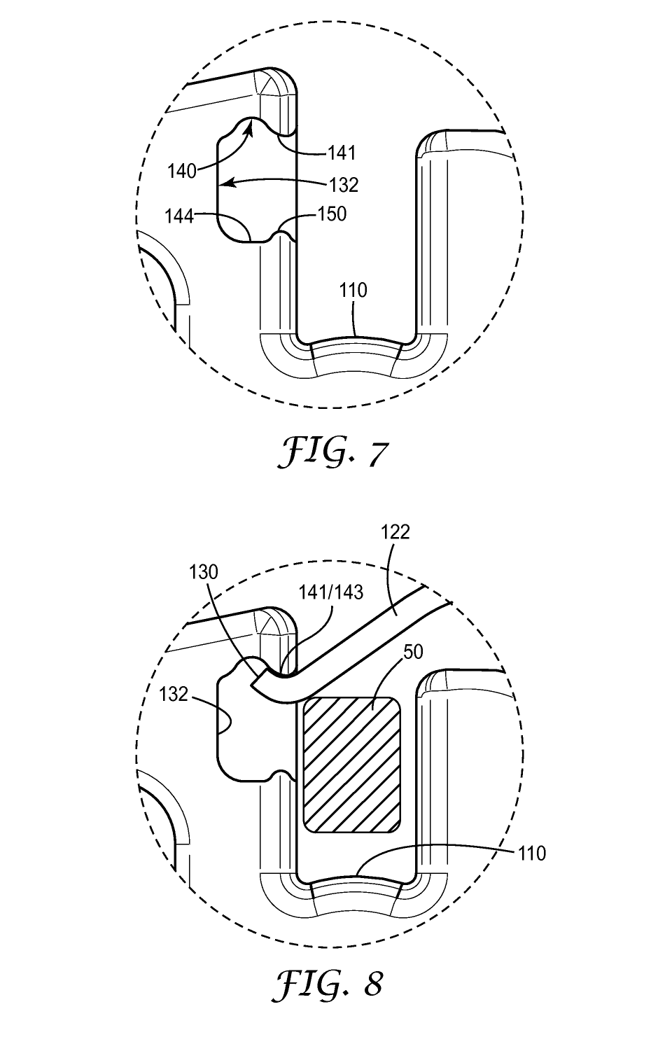

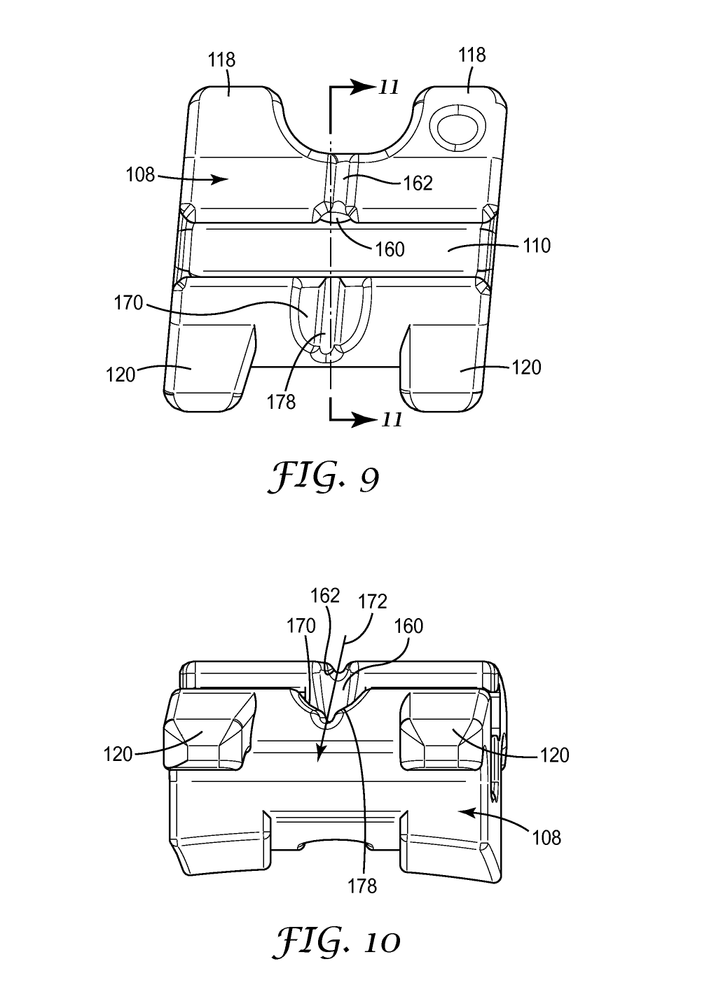

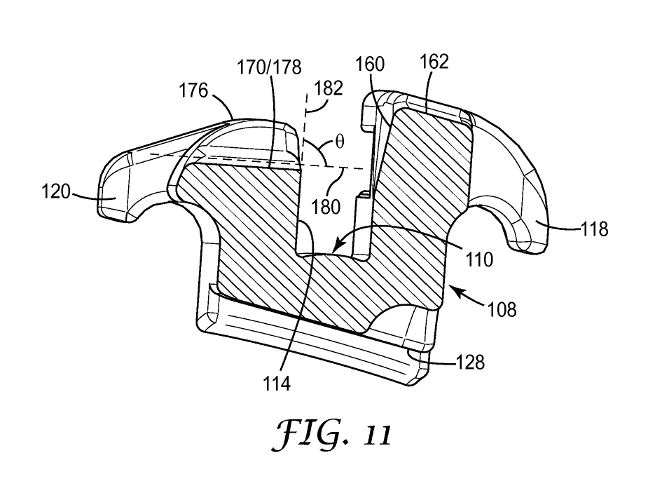

FIGS. 5-10 show the body 108 with the clip 122 and base 102 removed, revealing additional exemplary features. For example, FIG. 5 shows a groove 170 located on the labial face of the body 108 disposed on the opposite side of the archwire slot 110 from the cavity 160. The groove 170 travels along a generally occlusal-gingival direction and is generally aligned with the cavity 160 along a common occlusal-gingival axis 172.

One major benefit provided by the groove 170 relates to ease of use, particularly when sliding the clip 122 from its closed position to its open position. As mentioned previously, this is generally accomplished using a pointed tip of a hand instrument. One shortcoming of prior art embodiments is that dragging the tip of the instrument across the archwire slot to open the clip can cause the tip to collide with the opposing side wall of the slot. This interference could be perceived by the practitioner as a jammed clip, even when there was no actual obstruction between the clip 122 and the body 108. To overcome this interference, the practitioner might be compelled to pull the tip of the instrument “upward,” or labially, which could result in deformation of the clip. In the configuration shown in FIG. 5, potentially interfering portions of the occlusal side wall 114 are displaced by the groove 170, which allows the instrument tip to pass freely between the mesial and distal halves of the body 108.

Another benefit of the groove 170 relates to the posturing of forces applied by the tip of a hand instrument engaged to the cavity 160. When the tip of the hand instrument is inserted into the cavity 160 and drawn along the groove 170, the presence of the groove 170 allows the tip to impart a force vector to the clip 122 that avoids unduly straining the labial and lingual legs 124, 126 in directions apart from each other. In a preferred embodiment, the groove 170 guides the tip along a generally linear path of movement offset in the lingual direction from the labial side 176 of the body 108.

This is shown in the side view of FIG. 11, which provides a cross-section view of the groove 170 on the labial side 176 of the body 108. When the tip of a hand instrument is inserted in the cavity 160 and drawn toward the occlusal direction to open the clip 122 (not shown in this figure), the tip of the instrument traces a path 180 that begins where the tip contacts the clip 122 and extends in a generally occlusal direction. Because of the relief afforded by the groove 170, it is possible for the path 180 to be offset in a lingual direction from the labial side 176 of the body 108.

FIG. 11 further shows that the path 180 is generally linear and intersects the reference plane 182 from the gingival direction as the clip 122 slides from its closed to its open position. On the other hand, when the clip 122 is sliding from its open to its closed position, the tip of the instrument traces back along the same path 180, this time intersecting the reference plane 182 from the occlusal direction. As shown in FIG. 11, the path 180 is oriented at an angle θ relative to the reference plane 182. When the angle θ is significantly greater than 90 degrees, the force applied to the clip 122 has an upward component (i.e. the labial leg 126 is being pulled toward the labial direction when opening the clip 122). On the other hand, when the angle θ is significantly below 90 degrees, the force applied to the clip 122 has a downward component (i.e. the labial leg 126 is “pushed” toward the lingual direction when opening the clip 122).

In some embodiments, the angle θ is at least 70, at least about 75 degrees, at least about 80 degrees, at least about 85 degrees, or at least about 90 degrees. In some embodiments, the angle is at most about 110 degrees, at most about 105 degrees, at most about 100 degrees, at most about 95 degrees, or at most about 90 degrees. In a preferred embodiment, the path 180 is generally perpendicular to the reference plane 182. Having an angle θ that is near 90 degrees can help keep the clip 122 in a neutral, unstressed state while sliding it open and closed, and avoid permanently deforming the lingual and labial legs 124, 126 relative to each other.

Additional optional features are illustrated. Like the cavity 160, the groove 170 also has a shallow occlusal-gingival scribe line 178, shown in FIG. 5. The scribe line 178 is aligned with the scribe line 162 and visible through the central notch 134 when the clip 122 (not shown in this figure) is in its opened position, assisting the practitioner in positioning the appliance 100 on the tooth during a bonding procedure. As shown in FIG. 11, the scribe lines 162 and 178 are both aligned along the common reference axis 172 in labial plan view.

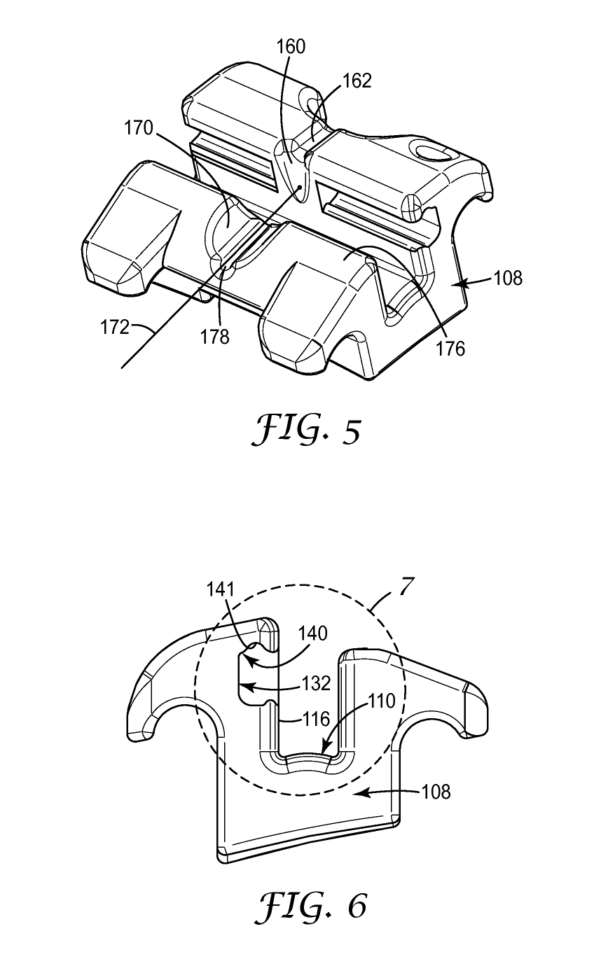

Another optional feature is shown in FIGS. 6-8, which show enlarged side views of the retaining recess 132. As shown, the lingual-facing surface 140 of the retaining recess 132 includes a third locking surface 141. Optionally and as shown in FIG. 8, the third locking surface 141 is a convex surface that registers, and matingly engages with, a corresponding fourth concave locking surface 143 on the clip 122. The fourth locking surface 143 is parallel to, and adjacent, the leading edge 130 of the clip 122 and substantially conforms to the third locking surface 141 on the lingual-facing surface 140. Other aspects of the locking surfaces 141,143 may be similar to those of locking surfaces 150, 152 and will not be repeated here.

Having mating locking surfaces 141, 143 on the lingual-facing surface 140 of the retaining recess 132 can be beneficial when deflection of an archwire 50 causes contact with the clip 122 and urges the outer end of the clip 122 toward the labial direction. In conventional self-ligating appliances, such forces could cause the outer end of the clip to slip out of the retaining recess and cause spontaneous disengagement of the archwire from the slot. This situation may be encountered, for example, when the clip functioning in an “active” mode, where there is often continuous contact between at least a part of the archwire and clip. The advantageous configuration shown in FIG. 8 avoids disengagement by locking the end of the clip 122 with the lingual-facing surface 140 of the retaining recess 132. As shown, the engagement between surfaces 141, 143 creates an interference that restricts sliding between these components, providing for a more secure ligation of the archwire 50.

### Embodiments

1. An orthodontic appliance comprising: a base; a body extending outwardly from the base and having an elongated slot thereon that extends along a generally mesial-distal direction, the slot having a bottom wall and pair of opposing occlusal and gingival side walls; a clip slidably engaged to the body and movable between open and closed positions, the clip comprising a first leg extending over at least a portion of the slot when the clip is in its closed position and a second leg joined to the first leg and slidably received in a passageway extending through the body along a generally occlusal-gingival direction; and a cavity located on the labial side of the appliance and comprising a concave side surface that interrupts a side wall of the slot, the cavity collectively defined by the body and labial leg when the clip is in its closed position and having a size sufficient to accommodate the tip of a hand instrument.
2. The appliance of embodiment 1, wherein the first leg is a labial leg whose first locking surface faces a generally lingual direction and the second leg is a lingual leg whose second locking surface faces a generally labial direction.
3. The appliance of embodiment 1 or 2, wherein the first locking surface comprises a convex surface and the second locking surface comprises a concave surface.
4. The appliance of embodiment 2, wherein the cavity further comprises a concave side surface located on the labial leg and opposing the concave side surface on the body.
5. The appliance of embodiment 1 or 4, further comprising:

a retaining recess located on one of the side walls for receiving the leading edge, wherein the first leg has a leading edge and a first locking surface adjacent the leading edge, and the retaining recess comprising a second locking surface and the clip being compressively pre-stressed whereby the first and second locking surfaces urge against, and complementally engage, each other to retain the clip in its closed position.

6. The appliance of embodiment 1 or 4, wherein the side wall interrupted by the cavity is a gingival side wall.
7. The appliance of embodiment 6, wherein the concave side surface on the body is substantially inscribed within a cylinder intersecting the gingival side wall.

8. The appliance of embodiment 7, wherein the cylinder has a radius ranging from about 127 micrometers to about 762 micrometers.

9. The appliance of embodiment 8, wherein the cylinder has a radius ranging from about 152 micrometers to about 508 micrometers.
10. The appliance of embodiment 9, wherein the cylinder has a radius ranging from about 178 micrometers to about 254 micrometers.
11. The appliance of embodiment 1 or 4, wherein the cavity is located approximately at the mesial-distal midpoint of the gingival side wall.
12. The appliance of embodiment 1 or 4, further comprising a groove located on a labial side of the body on an opposite side of the slot from the cavity and generally aligned with the cavity along a common occlusal-gingival axis.
13. The appliance of embodiment 1 or 4, wherein the first leg of the clip extends essentially along the entire mesial-distal length of the slot.
14. The appliance of embodiment 5, wherein the retaining recess has a bottom surface facing a generally occlusal direction and a pair of opposing side surfaces facing generally labial and lingual directions, the concave surface being located on the generally labial-facing side surface.
15. The appliance of embodiment 14, wherein at least a portion of the concave surface has a normal vector with a positive component in the gingival direction.
16. The appliance of embodiment 5, wherein the retaining recess is a first retaining recess and wherein the body comprises a second retaining recess, the first and second retaining recesses located on respective mesial and distal sides of the slot, and the leading edge being divided into spaced-apart mesial and distal sections received in the respective first and second retaining recesses when the clip is in its closed position.
17. The appliance of embodiment 5, wherein the retaining recess further comprises a third locking surface facing a generally lingual direction that complementally engages a fourth locking surface facing a generally labial direction adjacent the leading edge when the clip is in an active mode.
18. The appliance of embodiment 17, wherein the third locking surface is a convex surface and the fourth locking surface is a concave surface.
19. A method of actuating an orthodontic appliance having a body and a generally “U”-shaped clip slidably engaged to the body and having a first and second leg, the first leg at least partially extending across an elongated slot located on the body, the method comprising:

inserting the tip of a hand instrument into a cavity disposed along a space between the first leg and outward-facing side of the body, the cavity being at least partially defined by both the first leg and body to provide tactile feedback along both outward-facing and occlusal-facing surfaces; and

drawing the tip along a groove located on the outward-facing side of the body and extending along generally occlusal-gingival direction on an opposite side of the slot from the cavity thereby applying a force vector to the clip that avoids straining the first and second legs in directions apart from each other.

20. The method of embodiment 19, wherein the first leg is a labial leg, the second leg is a lingual leg, and the outward-facing side is a labial side.
21. The method of embodiment 20, wherein the groove guides the tip along a generally linear path of movement offset in a lingual direction from the labial side of the body.
22. The method of embodiment 21, wherein the linear path intersects a reference plane coplanar with one of the side walls of the slot at an angle ranging from about 70 degrees to about 110 degrees.
23. The method of embodiment 22, wherein the first and second linear paths intersect at an angle ranging from about 80 degrees to about 100 degrees.
24. The method of embodiment 23, wherein the first and second linear paths intersect at an angle ranging from about 85 degrees to about 95 degrees.
25. The method of embodiment 21, wherein drawing the tip along the groove causes the lingual leg to slide in a generally occlusal direction.

All of the patents and patent applications mentioned above are hereby expressly incorporated into the present disclosure. The foregoing invention has been described in some detail by way of illustration and example for purposes of clarity and understanding. However, various alternatives, modifications, and equivalents may be used and the above description should not be taken as limiting in the scope of the invention which is defined by the following claims and their equivalents.

1. An orthodontic appliance comprising:
a base;
a body extending outwardly from the base and having an elongated slot thereon that extends along a generally mesial-distal direction, the slot having a bottom wall and pair of opposing occlusal and gingival side walls;
a clip slidably engaged to the body and movable between open and closed positions, the clip comprising a first leg extending over at least a portion of the slot when the clip is in its closed position and a second leg joined to the first leg and slidably received in a passageway extending through the body along a generally occlusal-gingival direction; and
a cavity located on the labial side of the appliance and comprising a concave side surface that interrupts a side wall of the slot, the cavity collectively defined by the body and labial leg when the clip is in its closed position and having a size sufficient to accommodate the tip of a hand instrument.

2. The appliance of claim 1, wherein the first leg is a labial leg whose first locking surface faces a generally lingual direction and the second leg is a lingual leg whose second locking surface faces a generally labial direction.

3. The appliance of claim 1 wherein the first locking surface comprises a convex surface and the second locking surface comprises a concave surface.

4. The appliance of claim 2, wherein the cavity further comprises a concave side surface located on the labial leg and opposing the concave side surface on the body.

5. The appliance of claim 1, further comprising:
a retaining recess located on one of the side walls for receiving the leading edge, wherein the first leg has a leading edge and a first locking surface adjacent the leading edge, and the retaining recess comprising a second locking surface and the clip being compressively pre-stressed whereby the first and second locking surfaces urge against, and complementally engage, each other to retain the clip in its closed position.

6. The appliance of claim 1, wherein the side wall interrupted by the cavity is a gingival side wall.

7. The appliance of claim 6, wherein the concave side surface on the body is substantially inscribed within a cylinder intersecting the gingival side wall.

8. The appliance of claim 7, wherein the cylinder has a radius ranging from about 127 micrometers to about 762 micrometers.

9. The appliance of claim 1, wherein the cavity is located approximately at the mesial-distal midpoint of the gingival side wall.

10. The appliance of claim 1, further comprising a groove located on a labial side of the body on an opposite side of the slot from the cavity and generally aligned with the cavity along a common occlusal-gingival axis.

11. The appliance of claim 1, wherein the first leg of the clip extends essentially along the entire mesial-distal length of the slot.

12. The appliance of claim 5, wherein the retaining recess has a bottom surface facing a generally occlusal direction and a pair of opposing side surfaces facing generally labial and lingual directions, the concave surface being located on the generally labial-facing side surface.

13. The appliance of claim 12, wherein at least a portion of the concave surface has a normal vector with a positive component in the gingival direction.

14. The appliance of claim 5, wherein the retaining recess is a first retaining recess and wherein the body comprises a second retaining recess, the first and second retaining recesses located on respective mesial and distal sides of the slot, and the leading edge being divided into spaced-apart mesial and distal sections received in the respective first and second retaining recesses when the clip is in its closed position.

15. The appliance of claim 5, wherein the retaining recess further comprises a third locking surface facing a generally lingual direction that complementally engages a fourth locking surface facing a generally labial direction adjacent the leading edge when the clip is in an active mode.

16. A method of actuating an orthodontic appliance having a body and a generally “U”-shaped clip slidably engaged to the body and having a first and second leg, the first leg at least partially extending across an elongated slot located on the body, the method comprising:
inserting the tip of a hand instrument into a cavity disposed along a space between the first leg and outward-facing side of the body, the cavity being at least partially defined by both the first leg and body to provide tactile feedback along both outward-facing and occlusal-facing surfaces; and
drawing the tip along a groove located on the outward-facing side of the body and extending along generally occlusal-gingival direction on an opposite side of the slot from the cavity thereby applying a force vector to the clip that avoids straining the first and second legs in directions apart from each other.

17. The method of claim 16, wherein the first leg is a labial leg, the second leg is a lingual leg, and the outward-facing side is a labial side.

18. The method of claim 17, wherein the groove guides the tip along a generally linear path of movement offset in a lingual direction from the labial side of the body.

19. The method of claim 18, wherein the linear path intersects a reference plane coplanar with one of the side walls of the slot at an angle ranging from about 70 degrees to about 110 degrees.

20. The method of claim 18, wherein drawing the tip along the groove causes the lingual leg to slide in a generally occlusal direction.
